(19) United States
(12) Patent Application Publication
(10) Pub. No.: US 2016/0192665 A1
(43) Pub. Date: Jul. 7, 2016

(54) METHOD FOR PREPARING BIRDS FOR FOOD PRODUCTS, AND FOOD PRODUCTS

(71) Applicant: Eugene D. Gagliardi, Cochranville, PA (US)

(72) Inventor: Eugene D. Gagliardi, Cochranville, PA (US)

(21) Appl. No.: 14/973,124

(22) Filed: Dec. 17, 2015

Related U.S. Application Data
(60) Provisional application No. 62/093,280, filed on Dec. 17, 2014.

(51) Int. Cl. A22C 21/00; A23B 4/044

(52) U.S. Cl. CPC A22C 21/0076; A23B 4/044; A23V 2002/00

(57) ABSTRACT

A method of preparing a bird to provide edible food products that are produced to conserve portions of the bird parts and bird products resulting from the use of the method. Preferred embodiments of the method utilize the drumsticks of the bird and apply the method to manipulate the drumsticks by making a plurality of cuts to provide a unique food item, including, for example, a mini chicken osso bucco and a mini or half leg.

### CROSS REFERENCE TO RELATED APPLICATIONS

This application claims the benefit of U.S. provisional Application No. 62/093,280, which was filed on Dec. 17, 2014 and which is incorporated herein by reference in its entirety.

### BACKGROUND OF THE INVENTION

1. Field of the Invention

The present invention relates generally to birds, and in particular, chickens and other poultry or fowl and the like, and, more particularly, to methods of preparing a bird to provide edible food products that are produced to conserve portions of the bird parts and bird products resulting from the use of the methods.

2. Brief Description of the Related Art

Birds, such as poultry and fowl, are conventionally eviscerated, dressed and sold either as a whole bird or as separate parts, i.e., breasts, thighs, wings, etc. One of the parts which is often separated and sold is the drumstick. Typically the drumsticks are sold with the skin in place and generally have the leg bone extending through the drumstick.

In recent years, there has been an increasing demand for innovative meat products, particularly products which require less time for preparation and which include little or no waste. There also is a benefit to use more of the bird or bird part, as this promotes conservation and reduces waste.

### SUMMARY OF THE INVENTION

The present invention includes methods that utilize birds, and in particular, chickens and other poultry or fowl and the like, and products produced by the methods. The method involves preparing the bird part to conserve the bird and minimize or eliminate waste. Particular preferred embodiments of the invention involve the use of the drumstick of a bird and manipulating the drumstick to produce one or more edible food products.

The methods are carried out to produce food products which are attractive and may be served at functions, used by caterers, or used by an individual for daily dining or for presentation of an attractive food product for special occasions, parties, events and functions. The food products, although made from the drumsticks of a bird or fowl, and are produced to conserve the meat, nonetheless, are still attractive.

The methods are designed to provide one or more food products from a single drumstick of a bird, and the food products produced by the methods are not only attractive, but are fun and easy to eat. In some cases, the food products produced by the methods of the invention are easy to hold and easy to eat while holding the product. This makes it a convenient food for parties and events where individuals are not seated when presented with food products such as hors d'oeuvres served butler style (e.g., distributing food (e.g., hors d'oeuvres) for consumption contained on a tray to standing party attendees), and for parties and events where individuals are not seated when consuming food products such as hors d'oeuvres. In one preferred embodiment of the invention, the inventive food product is designed to be suitable as an hors d'oeuvre or appetizer, capable of being served on a tray carried among standing party attendees.

Objects and advantages of the invention are to take a bird product, such as, for example, chickens, other poultry or fowl and the like, and utilize the drumsticks thereof and apply the methods to manipulate the drumsticks by cutting and/or reworking to provide unique food items. The food items may be further enhanced with accompanying items, such as strips of bacon or the like.

### BRIEF DESCRIPTION OF THE DRAWING FIGURES

FIG. 1 is a front view of a pair of chicken drumsticks showing a preferred cutting application according to a preferred method of the invention.

FIG. 2 is a top perspective view of a plurality of mini chicken legs or half legs produced according to a preferred method of the invention, shown cooked.

FIG. 3 is a top perspective view of a plurality of mini chicken osso buccos (also referred to as “petite osso buccos”) produced according to a preferred method of the invention, shown uncooked.

FIG. 4 is a view in perspective of a drumstick 111 showing its leg bone 112 therein in phantom and showing another preferred cutting application according to a preferred embodiment of the invention.

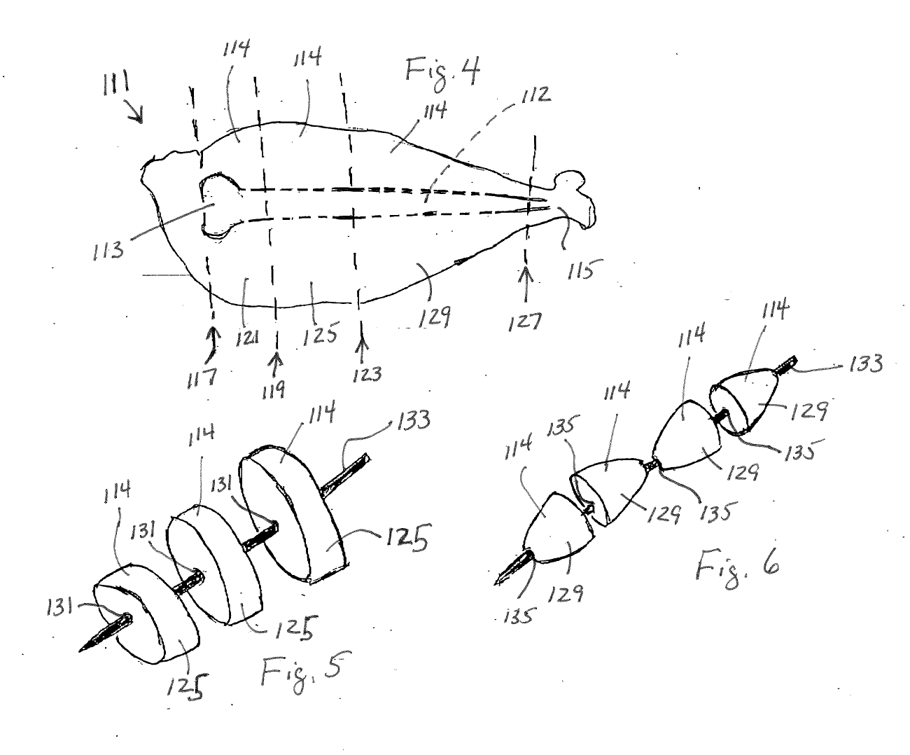

FIG. 5 is a view in perspective and FIG. 7 is a top perspective view, both showing a plurality of food products 125 produced in accordance with the invention, shown uncooked, mounted on a skewer 133 in FIG. 5 and on two skewers 133 in FIG. 7, with the skewer 133 extending through the hollow portion 131 of the leg bone 112 that remains in each food product 125.

FIG. 6 is a view in perspective and FIG. 8 is a top perspective view, both showing a plurality of food products 129 produced in accordance with the invention, shown uncooked, mounted on a skewer 133 in FIG. 6 and on two skewers 133 on FIG. 8 with the skewer 133 extending through the hollow portion 135 of the leg bone 112 that remains in each food product 129.

Further figures and material are appended to this application and show additional depictions of the mini chicken legs and mini or petite osso buccos. In addition, appended hereto is a listing showing an example of yields of product in connection with the method and its application to birds, such as poultry.

### DETAILED DESCRIPTION OF THE INVENTION

The inventive methods and food products produced thereby utilize birds, and in particular edible birds, including those, such as chickens, and other fowl that are used for consumption. The inventive methods are carried out using the drumstick, and manipulating the drumstick to form food products therefrom. According to a preferred embodiment, the inventive method produces a plurality of food products from a single drumstick. The drumstick generally is supplied or obtained with the skin on. In each embodiment of the invention, the skin may be left on the drumstick, or, if desired, the skin may be removed before or after the cuts discussed below are made. The drumstick may be attached to another part of the bird, such as, for example, the thigh part, and, if it is, it is preferred to remove the drumstick therefrom.

According to one preferred embodiment for carrying out the method, the drumstick is prepared to produce food products. The drumstick has a starting weight, and there generally are a number of drumsticks per pound. The drumstick has a drumstick joint at a thigh joint end at one end of the drumstick, an ankle joint at the end of the drumstick opposite the thigh joint end, and a leg bone spanning between the two ends. According to a preferred process, the drumstick portion of the bird leg is obtained for use. The skin of the drumstick preferably is pulled up to the thigh joint end of the drumstick. According to preferred embodiments, the drumstick is then firmed up. One preferred way to firm up the drumstick is to subject it to cooling, preferably in a freezer. It is preferred that the drumstick not be entirely frozen, but that freezing occur only to the extent to crust freeze the drumstick (so that the edge of the drumstick freezes on the surface, but not throughout).

The inventive method involves making cuts to the drumstick. According to a preferred embodiment, the cuts may be made with a suitable instrument, such as, for example, a poultry saw. The method may be carried out by making a series of cuts. One cut involves squaring off the thigh joint end of the drumstick. Another cut, or second cut, is made at a distance from the squared off end of the drumstick. This second cut produces a first food product that may be referred to as a mini chicken osso bucco (in the case of a chicken drumstick). The first food product or mini osso bucco preferably may be about 1 ½ inches in height or thickness. Although this is one preferred thickness, other thicknesses may be possible, depending on the size of the bird used, and the size of the product desired.

The inventive method also produces an additional or second food product from the same drumstick. According to a preferred embodiment of the method, a cut is made at the ankle joint end of the drumstick. This cut involves removing the ankle joint from the drumstick. This cut may be the third cut, and when the third cut and previously discussed second cut are made, there is a food product created that resembles a cone-shaped half leg (or mini-leg). This food product may be cooked and dressed like hot wings. The end of the half leg is preferably exposed from the flesh so that only the bone is exposed at the end of the half leg and so that the food product contains a handle for holding, the handle being the exposed bone at the end of the half leg.

The half or mini leg may make use of the leg bone so that the leg bone portion that is exposed may be used for holding. In addition, the osso bucco may be fitted with a stick or other component so that it may be held.

The method therefore, may produce two food products from the drumstick with a first cut, a second cut, and a third cut made to the drumstick. According to a preferred embodiment of the inventive method, the two food products produced from the three cuts are a petite osso bucco product (a mini chicken osso bucco product) and the mini-leg (half leg) product. The method utilizes basically the entire drumstick, and produces minimal or no waste since the removed portion of the drumstick joint at the thigh joint end of the drumstick, the ankle joint, and in some embodiments, the skin, if it is removed, may be used to make stock.

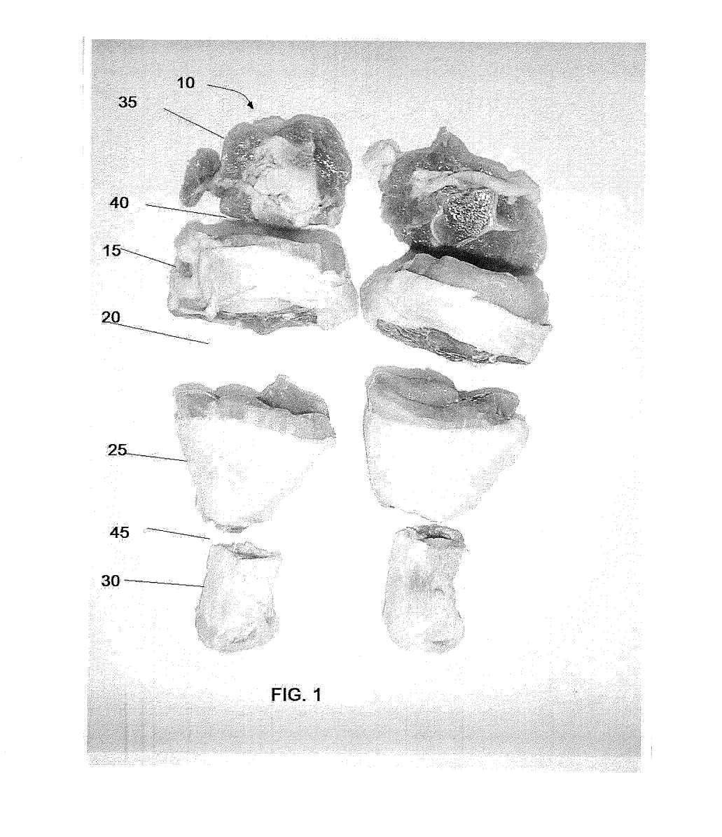

Referring to FIG. 1, a preferred implementation of the method is illustrated. In this example illustrating the invention, the bird is poultry, and in particular a chicken drumstick 10 is used. The chicken drumstick 10 is shown in FIG. 1 and the method of processing it is described as follows, and the other drumstick shown in FIG. 1 may be processed in accordance with the method described and carried out on the drumstick 10. In the depiction of FIG. 1, the drumstick 10 is shown with the skin on. According to preferred embodiments, the skin is left on the drumstick, or alternatively, according to some embodiments, if the skin is to be removed, it may be removed before or after the cuts discussed below are made. Preferably, before any of the cuts discussed below are made, the drumstick 10 is firmed up. One preferred way to firm up the drumstick 10 is to subject it to cooling, preferably in a freezer. It is preferred that the drumstick 10 not be entirely frozen, but that freezing occur only to the extent to crust freeze the drumstick 10 (so that the edge of the drumstick 10 freezes on the surface, but not throughout). A first cut 40, preferably using a poultry saw or a chef's knife, is made at the top of the drumstick 10 to preferably square off the thigh joint end of the drumstick 10 and to remove a portion of the drumstick joint 35 at the thigh joint end 50 of the drumstick 10. The cut 40 is made preferably through the drumstick joint 35 at the thigh joint end 50 of the drumstick 10, leaving a portion of the drumstick joint 35 attached to the leg bone extending through the drumstick 10. A second cut 20 is made below the first cut 40 (preferably 1 ½ inches below the first cut 40) and separates the upper portion 15 that is in this embodiment of the invention the osso bucco item, from the lower portions 25 and 30 of the drumstick 10. Preferably, the second cut 20 is made using a poultry saw or pruning shears. If pruning shears are used in making the second cut 20, preferably the meat around the bone at the second cut 20 site first is cut with a knife completely around the bone using a slight, even pressure as to not splinter the bone. Then, the pruning shears are used to cut through the bone to complete the second cut 20. If a poultry saw is used, there is no need to cut the meat around the bone at the second cut 20 site with a knife. A third cut 45 is preferably made slightly above the ankle joint 30, preferably using pruning shears or a poultry saw, to remove the ankle joint 30 from the lower end portion of the drumstick 10. The portion 25 may be further manipulated to form a cone shaped half leg or mini leg. Preferably, the portion 25 is inverted to stand with the bone of the drumstick 10 at the cut 45 being up (i.e., the end of the drumstick 10 from which the ankle joint 30 has been removed being up and the end of the portion 25 at the cut 20 being down) and the meat is pushed downwardly toward the end of the portion 25 at the cut 20 to expose a portion 55 of the leg bone at the end of the portion 25 at the cut 45, thereby forming a handle by which portion 25 may be held.

In one preferred embodiment, my invention includes a method of producing a plurality of food products from a single drumstick 10 of a bird, the drumstick 10 having a first end portion including a drumstick joint 35 that formed at least a portion of a thigh joint, a second end portion including at least a portion of an ankle joint 30, a leg bone extending between the first and second end portions of the drumstick 10, and meat surrounding at least a portion of the leg bone. In this preferred embodiment, my inventive method comprises making a first cut 40 completely through the drumstick 10 at the first end portion of the drumstick 10 generally perpendicular to the leg bone to square off the first end portion of the drumstick 10, making a second cut 20 completely through the drumstick 10 at, for example, about 1 ½ inches from the first cut 40, producing a first food product 15 defined by a portion of the drumstick 10 positioned between the first cut 40 and the second cut 20, and making a third cut 45 completely through the drumstick 10 at the second end portion of the drumstick 10 so that the ankle joint 30 is completely removed from the leg bone, producing a second food product 25 defined by a portion of the drumstick 10 positioned between the second cut 20 and the third cut 45.

Preferably, prior to making the cuts 40, 20, 45 in the drumstick 10, the drumstick 10 is firmed up, preferably by crust freezing the drumstick 10.

In this preferred embodiment of the invention, if the first cut 40 is made at the first end portion of the drumstick 10 through the drumstick joint 35, resulting in at least a portion of the drumstick joint 35 remaining on the leg bone, the first food product 15 produced in accordance with this preferred embodiment of the invention is a mini bird osso bucco, which is sold under the trademark “HOTWHEELS” by Creativators LLC, of Cochranville, Pa.

However, if the first cut 40 is made at the first end portion of the drumstick 10 below the drumstick joint 35 so that the drumstick joint 35 is completely removed from the leg bone, the inventive method may further include the step of curing the first food product 15 as a ham is cured. For instance, the first food product 15 may be cured using a dry cure method, such as in which a curing mixture (e.g., a ground mixture of salt, herbs, and spices) is rubbed onto or used to completely cover the first food product 15 for about 2 to 3 days, followed by washing and then air drying. Then, preferably, the first food product 15 is subjected to a smoking process, such as in a smokehouse. Also, the first food product 15 may be cured using a wet cure method, such as in which a solution of salt, brown sugar, herbs, spices, and water is boiled, then cool, and then used to completely cover the first food product 15 for about 2 to 3 days, followed by removal of the first food product 15 from the solution to be washed, dried off, and then air dried. Then, preferably, the first food product 15 is subjected to a smoking process, such as in a smokehouse. The cured first food product 15 is sold under the trademark “HAMKINS” by Creativators LLC, of Cochranville, Pa.

In this preferred embodiment of the invention, preferably the second food product 25 is a mini bird leg. Also, preferably, the portion of the meat of the drumstick 10 on the second food product 25 is pushed toward the first end of the second food product 25 to expose a portion 55 of the leg bone at the second end of the second food product 25, thereby forming a handle with the portion 55 of the leg bone that is exposed in the second food product 25 by which the second food product 25 may be held.

In another preferred embodiment, my invention includes a method of producing a food product 15 from a drumstick 10 of a bird, the drumstick 10 having a first end portion including a drumstick joint 35 that formed at least a portion of a thigh joint, a second end portion including at least a portion of an ankle joint 30, a leg bone extending between the first and second end portions of the drumstick 10, and meat surrounding at least a portion of the leg bone. In this preferred embodiment, my inventive method comprises making a first cut 40 completely through the drumstick 10 at the first end portion of the drumstick 10 generally perpendicular to the leg bone to square off the first end portion of the drumstick 10, and making a second cut 20 completely through the drumstick 10 at, for example, about 1 ½ inches from the first cut 40, producing a food product 15 defined by a portion of the drumstick 10 positioned between the first cut 40 and the second cut 20.

Preferably, prior to making the cuts 40, 20 through the drumstick 10, the drumstick 10 is firmed up, preferably by crust freezing the drumstick 10.

In this preferred embodiment of the invention, if the first cut 40 is made at the first end portion of the drumstick 10 through the drumstick joint 35, resulting in at least a portion of the drumstick joint 35 remaining on the leg bone, the first food product 15 produced in accordance with this preferred embodiment of the invention is a mini bird osso bucco, which is sold under the trademark “HOTWHEELS” by Creativators LLC, of Cochranville, Pa.

However, if the first cut 40 is made at the first end portion of the drumstick 10 below the drumstick joint 35 so that the drumstick joint is completely removed from the leg bone, the inventive method may further include the step of curing the first food product 15 as a ham is cured. For instance, the first food product 15 may be cured using a dry cure method, such as in which a curing mixture (e.g., a ground mixture of salt, herbs, and spices) is rubbed onto or used to completely cover the first food product 15 for about 2 to 3 days, followed by washing and air drying. Then, preferably, the first food product 15 is subjected to a smoking process, such as in a smokehouse. Also, the first food product 15 may be cured using a wet cure method, such as in which a solution of salt, brown sugar, herbs, spices, and water is boiled, then cool, and then used to completely cover the first food product 15 for about 2 to 3 days, followed by removal of the first food product 15 from the solution to be washed, dried off, and then air dried. Then, preferably, the first food product 15 is subjected to a smoking process, such as in a smokehouse. The cured first food product 15 is sold under the trademark “HAMKINS” by Creativators LLC of Cochranville, Pa.

In another preferred embodiment, my invention includes a method of producing a food product 25 from a drumstick 10 of a bird, the drumstick 10 having a first end portion including a drumstick joint 35 that formed at least a portion of a thigh joint, a second end portion including at least a portion of an ankle joint 30, a leg bone extending between the first and second end portions of the drumstick, and meat surrounding at least a portion of the leg bone. In this preferred embodiment, my inventive method comprises making a cut 20 completely through the drumstick 10 at, for example, about 1 ½ inches from the first end portion of the drumstick 10, and making a cut 45 completely through the drumstick 10 at the second end portion of the drumstick 10 so that the ankle joint 30 is completely removed from the leg bone, producing a food product 25 defined by a portion of the drumstick 10 positioned between the cut 20 and the cut 45.

Preferably, prior to making cuts 20 and 45 through the drumstick 10, the drumstick 10 is firmed up, preferably by crust freezing the drumstick 10.

In this preferred embodiment of the invention, preferably the food product 25 is a mini bird leg. Also, preferably, the portion of the meat of the drumstick 10 on the food product 25 is pushed toward the first end of the food product 25 to expose a portion 55 of the leg bone at the second end of the food product 25, thereby forming a handle with the portion 55 of the leg bone that is exposed in the food product 25 by which the food product 25 may be held.

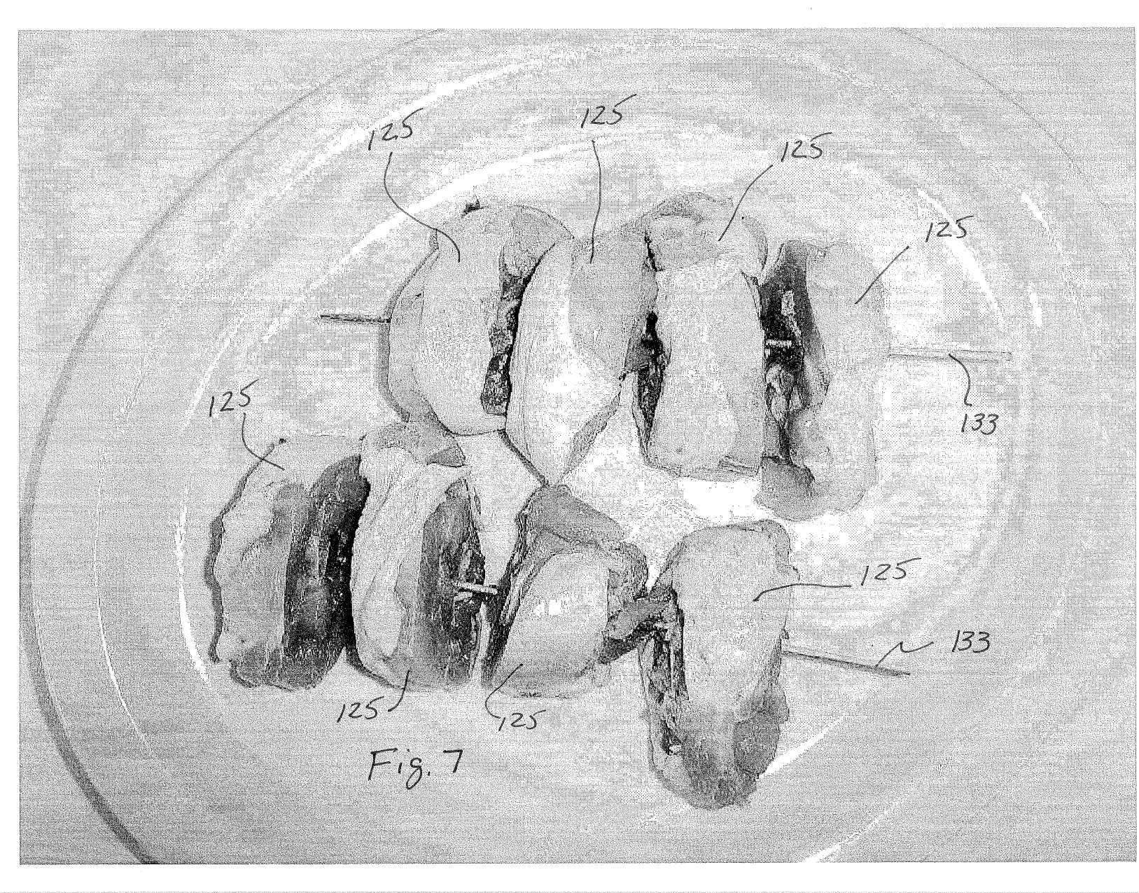

Referring to FIGS. 5-8, in another preferred embodiment, my invention includes a method of producing a plurality of food products from a single drumstick 111 of a bird, the drumstick 111 having a first end portion including a drumstick joint 113 that formed at least a portion of a thigh joint, a second end portion including at least a portion of an ankle joint 115, a leg bone 112 extending between the first and second end portions of the drumstick 111, and meat 114 surrounding at least a portion of the leg bone 112. In this preferred embodiment, my inventive method comprises making a first cut 117 completely through the drumstick 111 at the first end portion of the drumstick 111 generally perpendicular to the leg bone 112 to square off the first end portion of the drumstick 111, making a second cut 119 completely through the drumstick 111 at, for example, about 1 ½ inches from the first cut 117, producing a first food product 121 defined by a portion of the drumstick 111 positioned between the first cut 117 and the second cut 119, making a third cut 123 completely through the drumstick 111 at about midway between the second cut 119 and the second end portion of the drumstick 111, producing a second food product 125 defined by a portion of the drumstick 111 positioned between the second cut 119 and the third cut 123, and making a fourth cut 127 completely through the drumstick 111 at the second end portion of the drumstick 111 so that the ankle joint 115 is completely removed from the leg bone 112, producing a third food product 129 defined by a portion of the drumstick 111 positioned between the third cut 123 and the fourth cut 127.

Preferably, prior to making the cuts 117, 119, 123, and 127 in the drumstick 111, the drumstick is firmed up, preferably by crust freezing the drumstick 111.

In this preferred embodiment of the invention, if the first cut 117 made at the first end portion of the drumstick 111 is made through the drumstick joint 113, resulting in at least a portion of the drumstick joint 113 remaining on the leg bone 112, the first food product 121 produced in accordance with this preferred embodiment of the invention is a mini bird osso bucco, which is sold under the trademark “HOTWHEELS” by Creativators LLC, of Cochranville, Pa.

However, if the first cut 117 made at the first end portion of the drumstick 111 is made below the drumstick joint 113 so that the drumstick joint 113 is completely removed from the leg bone 112, the inventive method may further include the step of curing the first food product 121 as a ham is cured. For instance, the first food product 121 may be cured using a dry cure method, such as in which a curing mixture (e.g., a ground mixture of salt, herbs, and spices) is rubbed onto or used to completely cover the first food product 121 for about 2 to 3 days, followed by washing and then air drying. Then, preferably, the first food product 15 is subjected to a smoking process, such as in a smokehouse. Also, the first food product 121 may be cured using a wet cure method, such as in which a solution of salt, brown sugar, herbs, spices, and water is boiled, then cool, and then used to completely cover the first food product 121 for about 2 to 3 days, followed by removal of the first food product 121 from the solution to be washed, dried off, and then air dried. Then, preferably, the first food product 15 is subjected to a smoking process, such as in a smokehouse. The cured first food product 121 is sold under the trademark “HAMKINS” by Creativators LLC, of Cochranville, Pa.

In this preferred embodiment of the invention, preferably, as shown in FIGS. 5 and 7, the second food product 125, which includes a portion 131 of the leg bone 112 around which the drumstick meat 114 on the second food product 125 is positioned, may be placed on a skewer 133, such that the second food product 125 may be treated like a shish kabob. Since the portion 131 of the leg bone 112 is hollow, the skewer 133 may extend axially through the center of the portion 131 in the hollow space thereof.

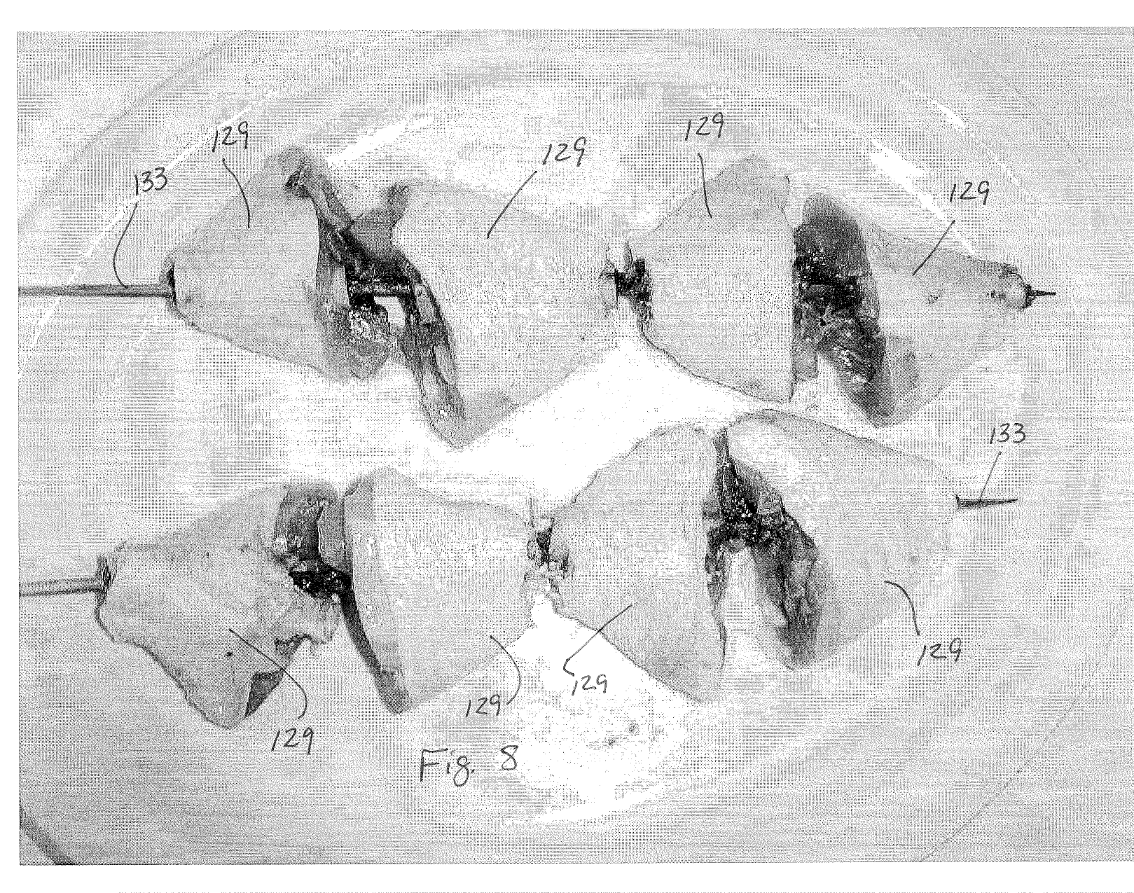

Also, in this preferred embodiment of the invention, preferably, as shown in FIGS. 6 and 8, the third food product 129, which includes a portion 135 of the leg bone 112 around which the drumstick meat 114 on the third food product 129 is positioned, may be placed on a skewer 133, such that the third food product 129 may be treated like a shish kabob. Since the portion 135 of the leg bone 112 is hollow, the skewer 133 may extend axially through the center of the portion 135 in the hollow space thereof.

Regarding the cuts 40, 20, 45, 117, 119, 123, and 127 mentioned above, cuts 40 and 117 preferably are made using a poultry saw or a chefs knife, cuts 20, 119, and 123 preferably are made using a poultry saw or pruning shears, and cuts 45 and 127 preferably are made using pruning shears or a poultry saw. If pruning shears are used in making cuts 20, 119, and 123, preferably the meat around the bone at the sites of cuts 20, 119, and 123 first is cut with a knife completely around the bone using a slight, even pressure as to not splinter the bone. Then, the pruning shears are used to cut through the bone to complete the cuts 20, 119, and 123. If a poultry saw is used to make the cuts 20, 119, and 123, there is no need to cut the meat around the bone at the sites of cuts 20, 119, and 123 with a knife.

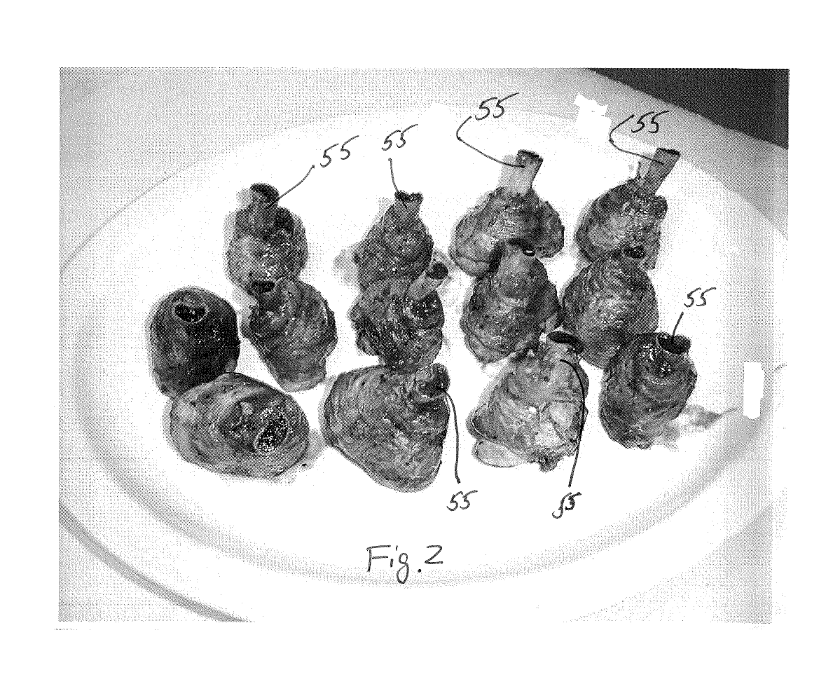

Referring to FIG. 2, there is illustrated a plurality of mini-chicken legs or half legs 25, formed using the methods described herein showing the portion 55 of the leg bone serving as a handle by which each item 25 may be held.

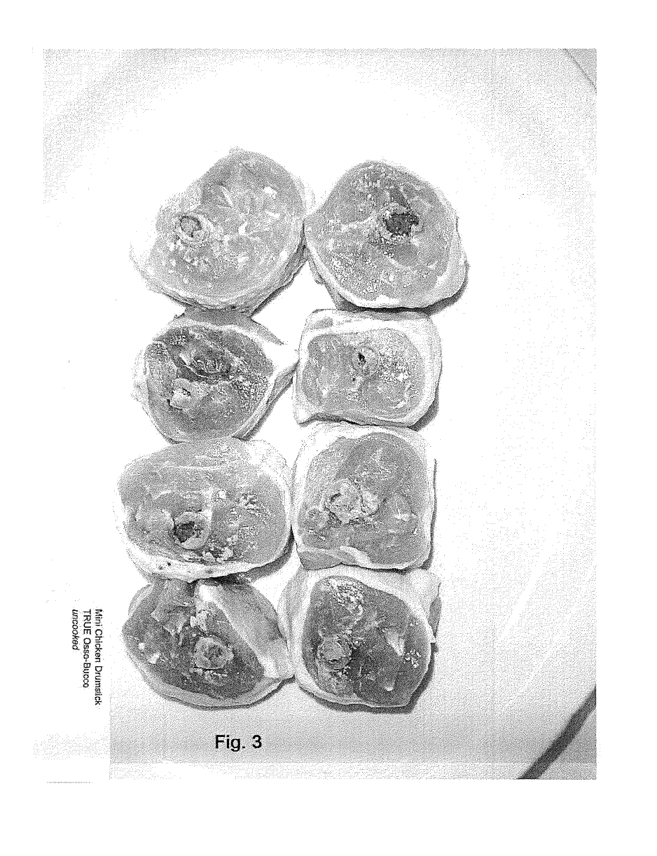

Referring to FIG. 3, there is illustrated a plurality of mini-chicken osso bucco products 15, formed using the methods described herein.

The food items, such as, for example, the osso bucco 15, may include further enhancements, such as, for example, being wrapped with bacon.

The inventive methods add value to under-utilized raw materials, resulting in value-added, high investment return/low cost marketable products. Starting with low-cost, raw material, the methods of the invention create the following unique, innovative, upscale products: 1) a true mini osso bucco; and 2) a mini-chicken leg which is a hot wing competitor that has more meat and is juicier than a chicken wing, that does not have joints, and that has its own handle.

The osso bucco product 15 of the invention may be seasoned and cooked like conventionally-known osso bucco, and the half legs (mini-legs) 25 of the invention may be seasoned and cooked like conventionally-known wings, such as hot wings.

Also, starting with low-cost raw material, the methods of the invention also create the following unique, innovative, upscale products: 1) a cured mini osso bucco; and 2) food products that easily mount on a skewer, such that the skewer extends through the hollow bone portion of such food products.

What is claimed is:

1. A method of producing a plurality of food products from a single drumstick of a bird, the drumstick having a first end portion including a drumstick joint that formed at least a portion of a thigh joint, a second end portion including at least a portion of an ankle joint, a leg bone extending between the first and second end portions of the drumstick, and meat surrounding at least a portion of the leg bone, the method comprising
making a first cut completely through the drumstick at the first end portion of the drumstick generally perpendicular to the leg bone to square off the first end portion of the drumstick,
making a second cut completely through the drumstick, producing a first food product defined by a portion of the drumstick positioned between the first and second cuts, and
making a third cut completely through the drumstick at the second end portion of the drumstick so that the ankle joint is completely removed from the leg bone, producing a second food product defined by a portion of the drumstick positioned between the second and third cuts.

2. The method of claim 1, further including the step of prior to making the cuts in the drumstick, firming up the drumstick.

3. The method of claim 1, further including the step of
prior to making the cuts in the drumstick, crust freezing the drumstick.

4. The method of claim 1, wherein the second cut in the drumstick is made 1 ½ inches from the first cut.

5. The method of claim 1, wherein the first cut is made at the first end portion of the drumstick through the drumstick joint, resulting in at least a portion of the drumstick joint remaining on the leg bone.

6. The method of claim 5, wherein the first food product is a mini bird osso bucco.

7. The method of claim 1, wherein the first cut is made at the first end portion of the drumstick below the drumstick joint so that the drumstick joint is completely removed from the leg bone.

8. The method of claim 7, further including the step of curing the first food product as a ham is cured.

9. The method of claim 1, wherein the second food product is a mini bird leg.

10. The method of claim 9, the second food product containing a portion of the meat, and further including the step of
pushing the portion of the meat on the second food product toward the first end of the second food product to expose a portion of the leg bone at the second end of the second food product, thereby forming a handle with the portion of the leg bone that is exposed in the second food product by which the second food product may be held.

11. The method of claim 1,
wherein the first cut is made at the first end portion of the drumstick through the drumstick joint, resulting in at least a portion of the drumstick joint remaining on the leg bone,
wherein the first food product is a mini bird osso bucco,
wherein the second food product is a mini bird leg,
the second food product containing a portion of the meat, and further including the step of
pushing the portion of the meat on the second food product toward the first end of the second food product to expose a portion of the leg bone at the second end of the second food product, thereby forming a handle with the potion of the leg bone that is exposed in the second food product by which the second food product may be held.

12. The method of claim 1,
further including the step of
prior to making the cuts in the drumstick, crust freezing the drumstick,
wherein the first cut is made at the first end portion of the drumstick through the drumstick joint, resulting in at least a portion of the drumstick joint remaining on the leg bone,
wherein the first food product is a mini bird osso bucco,
wherein the second food product is a mini bird leg,
the second food product containing a portion of the meat, and further including the step of
pushing the portion of the meat on the second food product toward the first end of the second food product to expose a portion of the leg bone at the second end of the second food product, thereby forming a handle with the potion of the leg bone that is exposed in the second food product by which the second food product may be held.

13. The method of claim 1,
wherein the first cut is made at the first end portion of the drumstick below the drumstick joint so that the drumstick joint is completely removed from the leg bone,
further including the step of
curing the first food product like a ham,
wherein the second food product is a mini bird leg,
the second food product containing a portion of the meat, and further including the step of
pushing the portion of the meat on the second food product toward the first end of the second food product to expose a portion of the leg bone at the second end of the second food product, thereby forming a handle with the potion of the leg bone that is exposed in the second food product by which the second food product may be held.

14. The method of claim 1,
further including the step of
prior to making the cuts in the drumstick, crust freezing the drumstick,
wherein the first cut is made at the first end portion of the drumstick below the drumstick joint so that the drumstick joint is completely removed from the leg bone,
further including the step of
curing the first food product like a ham,
wherein the second food product is a mini bird leg,
the second food product containing a portion of the meat, and further including the step of
pushing the portion of the meat on the second food product toward the first end of the second food product to expose a portion of the leg bone at the second end of the second food product, thereby forming a handle with the potion of the leg bone that is exposed in the second food product by which the second food product may be held.

15. A method of producing a food product from a drumstick of a bird, the drumstick having a first end portion including a drumstick joint that formed at least a portion of a thigh joint, a second end portion including at least a portion of an ankle joint, a leg bone extending between the first and second end portions of the drumstick, and meat surrounding at least a portion of the leg bone, the method comprising
making a first cut completely through the drumstick at the first end portion of the drumstick generally perpendicular to the leg bone to square off the first end portion of the drumstick,
making a second cut completely through the drumstick at about its midpoint producing a food product defined by a portion of the drumstick positioned between the first and second cuts.

16. The method of claim 15, further including the
prior to making the cuts through the drumstick, crust freezing the drumstick.

17. The method of claim 15, wherein the first cut is made at the first end portion of the drumstick through the drumstick joint, resulting in at least a portion of the drumstick joint remaining on the leg bone.

18. The method of claim 17, wherein the food product is a mini bird osso bucco.

19. The method of claim 15, wherein the first cut is made at the first end portion of the drumstick below the drumstick joint so that the drumstick joint is completely removed from the leg bone.

20. The method of claim 19, further including the step of
curing the food product like a ham.

21. A method of producing a food product from a drumstick of a bird, the drumstick having a first end portion including a drumstick joint that formed at least a portion of a thigh joint, a second end portion including at least a portion of an ankle joint, a leg bone extending between the first and second end portions of the drumstick, and meat surrounding at least a portion of the leg bone, the method comprising
making a cut completely through the drumstick at about its midpoint, and
making a cut completely through the drumstick at the second end portion of the drumstick so that the ankle joint is completely removed from the leg bone, producing a food product defined by a portion of the drumstick positioned between the cuts.

22. The method of claim 21, further including the step of
prior to making the cuts through the drumstick, crust freezing the drumstick.

23. The method of claim 21, wherein the food product is a mini bird leg.

24. The method of claim 23, the food product containing a portion of the meat, and further including the step of
pushing the portion of the meat on the food product toward the first end of the food product to expose a portion of the leg bone at the second end of the food product, thereby forming a handle with the portion of the leg bone that is exposed in the food product by which the food product may be held.

25. A method of producing a plurality of food products from a single drumstick of a bird, the drumstick having a first end portion including a drumstick joint that formed at least a portion of a thigh joint, a second end portion including at least a portion of an ankle joint, a leg bone extending between the first and second end portions of the drumstick, and meat surrounding at least a portion of the leg bone, the method comprising
making a first cut completely through the drumstick at the first end portion of the drumstick generally perpendicular to the leg bone to square off the first end portion of the drumstick,
making a second cut completely through the drumstick, producing a first food product defined by a portion of the drumstick positioned between the first and second cuts,
making a third cut completely through the drumstick between the second cut and the second end portion of the drumstick, producing a second food product defined by a portion of the drumstick positioned between the second cut and the third cut, and
making a fourth cut completely through the drumstick at the second end portion of the drumstick so that the ankle joint is completely removed from the leg bone, producing a third food product defined by a portion of the drumstick positioned between the third and fourth cuts.

26. The method of claim 25, further including the step of
prior to making the cuts in the drumstick, firming up the drumstick by crust freezing the drumstick.

27. The method of claim 25, wherein the second cut in the drumstick is made 1 ½ inches from the first cut.

28. The method of claim 25, wherein the first cut is made at the first end portion of the drumstick through the drumstick joint, resulting in at least a portion of the drumstick joint remaining on the leg bone.

29. The method of claim 28, wherein the first food product is a mini bird osso bucco.

30. The method of claim 25, wherein the first cut is made at the first end portion of the drumstick below the drumstick joint so that the drumstick joint is completely removed from the leg bone.

31. The method of claim 30, further including the step of
curing the first food product as a ham is cured.

32. The method of claim 25, wherein a portion of the leg bone of the drumstick remains in the second food product, said portion being hollow, and further including the step of
inserting a skewer into the hollow leg bone portion through one of its ends, thereby creating a handle for serving the second food product.

33. The method of claim 25, wherein a portion of the leg bone of the drumstick remains in the third food product, said portion being hollow, and further including the step of
inserting a skewer into the hollow leg bone portion through one of its ends, thereby creating a handle for serving the third food product.
